(19) United States
(12) Patent Application Publication
(10) Pub. No.: US 2012/0121313 A1
(43) Pub. Date: May 17, 2012

(54) MASSAGE DEVICE, IN PARTICULAR FOR THE SCALP

(75) Inventor: Laure Thiebaut, Clichy (FR)

(73) Assignee: L'OREAL, Paris (FR)

(21) Appl. No.: 13/120,864

(22) PCT Filed: Sep. 25, 2009
(86) PCT No.: PCT/EP2009/062432

§ 371 Date: Aug. 8, 2011

Related U.S. Application Data
(60) Provisional application No. 61/104,114, filed on Oct. 9, 2008.

(30) Foreign Application Priority Data
Sep. 26, 2008 (FR) 0805310

(51) Int. Cl. A61H 7/00; A45D 34/04

(52) U.S. Cl. 401/195; 601/136

(57) ABSTRACT

A massage device (10), in particular for the scalp, comprising support means (18, 22, 42) and massage fingers (20) that are pivotally mounted to the support means and that are configured to move apart from one another when they are pressed against the scalp, each finger being connected to the support means via hinge means (38) that define at least one pivot axis (40) for the finger, the support means including pivot-limiter means (62) for the fingers that define the most spaced-apart position for the fingers.

The present invention relates to a massage device, in particular for massaging the scalp, and to a cosmetic container fitted with the massage device. In the present application, the term “cosmetic” means a “cosmetic product” as defined in the Jun. 14, 1993 Council Directives 93/95/EEC.

Massage devices for the scalp are known that comprise support means carrying massage fingers, the fingers being of elongate and/or curved shape and including distal ends that are suitable for coming to bear against the scalp of a user in order to massage it. The fingers are distributed about an axis of the support means and they are designed so that their distal ends move apart from one another about the above-mentioned axis when they are pressed against the scalp. Such a massage device is referred to as a “massage spider”.

The scalp is massaged by moving the device in a direction that is approximately perpendicular to the scalp, in such a manner that the distal ends of the fingers move apart from one another and then move towards one another, sliding over the scalp. On moving apart, the fingers cause the scalp to stretch in directions that are oriented substantially radially relative to the above-mentioned axis of the support means. The distal ends of the fingers have dimensions that are relatively small, so that the bearing surfaces of said ends that bear against the scalp are relatively small.

Such a massage makes it possible to improve significantly blood circulation in the scalp and also the activity of hair roots, thereby resulting in hair loss being slowed down. When the massage is performed before applying a cosmetic such as a hair lotion, it also makes it possible to relax the scalp and improve the effects of the cosmetic.

Application No. US-A1-2003/0018285 describes a device of that type for massaging the head and the scalp, in which device the massage fingers are formed by flexible rods made out of a metal material having shape memory. However, while using that device, deformation of the rods is not controllable, and the distal ends of the rods move in random directions. In addition, after a certain period of use, the deformation capacity of the rods may change, and may be different from one rod to another. Such drawbacks lead to the scalp being massaged unevenly, and thus not very effectively.

Document DE-A1-10 2006 018 379 proposes a massage device comprising rigid massage fingers that are pivotally mounted via their proximal portions to a support. To do this, the proximal portions of the fingers are engaged in elongate slots in the support and they are surrounded by a resilient ring that urges the fingers towards a close-together position. However, that device presents drawbacks since the pivoting movements of the fingers are not accurate enough. The slots make it possible to guide the fingers in pivoting from their retracted position to a slightly spaced-apart position. Beyond that position, the proximal portions of the fingers are not guided sufficiently by the slots, and the movements of the fingers are not always identical. When the distal ends of the fingers are widely spaced apart from one another, there is also a high risk of the resilient ring giving way or becoming disengaged from the proximal portions of the fingers, and of the fingers becoming separated from the support. There are no actual connection means between the fingers and the support. There are also no effective means limiting the spacing or opening angle of the fingers. Finally, the manufacturing tolerances of the fingers and of the slots for receiving their proximal portions are such that it is difficult to mount the fingers so they fit closely in the slots. In practice, relatively large clearance can be observed between the proximal portions of the fingers and the slots, thereby leading to undesirable movements of the fingers, and thus to differences in the pivoting of the fingers.

In addition, a scalp massage device of the above-mentioned type is used independently of applying a cosmetic to the scalp by means of another device. It is thus necessary to have two independent devices that are used one after the other, one for massaging and the other for applying the cosmetic to the scalp, and that is not economical and causes the user to waste time.

Document U.S. Pat. No. 7,153,282 discloses a scalp massage device comprising six fingers, each of which is rotatably mounted via one of its ends to a support rod that is fastened on a frame that is movable in a vertical direction relative to the remainder of the device. The movement is obtained by means of eccentrics that co-operate with the frame and that are carried by a shaft that is rotated by a motor of the device. The eccentrics also co-operate with the frame so as to enable the frame and thus the fingers to move laterally relative to the eccentrics. The frame and the motor are housed in a housing comprising a top element and two bottom elements that are supported by the top element and that pivot relative to each other by means of a pin. The fingers can slide through rings carried by the bottom elements. The bottom elements and the fingers can be spaced apart from one another to a greater or lesser extent, and they are placed in a spaced-apart position by adjuster means that are carried by one of the bottom elements and that co-operate with the other bottom element.

However, in that device, the fingers pivot under drive from the motor and their positions are thus independent of the position of the device on the scalp. However, it is important for a scalp massage device to adapt to the shape of the head of its user and for its fingers to adopt massage positions as a function of the shape of the head so as to massage the entire scalp in even and uniform manner.

In addition, in that device, the fingers are guided merely by rings, and there are no special means that define precise maximum-spacing positions of the fingers. Document U.S. Pat. No. 5,054,504 discloses an appliance for applying a lotion to the scalp, the appliance comprising fingers arranged as a comb. However, that appliance does not make it possible to stretch and relax the scalp of the user in the same way as a massage spider, and does not provide effective massaging of the scalp.

The devices described in documents GB-A-888 778 and GB-A-442 105 make it possible to massage the scalp, but they favor pinching the skin rather than stretching it.

Massage and/or cosmetic applicator devices are also known comprising massage and/or applicator members that are generally smaller than the above-mentioned fingers of a massage spider and that are rigid or elastically deformable. Such devices are described in documents FR 07/56783, FR-A1-2 679 768, WO-A1-03/070312, EP-A1-1 825 842, WO-A2-03/065965, FR-A1-2 712 468, GB-A-313 823, GB-A-196 904, FR-A1-2 729 075, U.S. Pat. No. 687,363, GB-A-251 075, and US-A1-2007/0095780. Some of the devices make it possible to massage the skin of a person by applying the fingers of the device to the skin and by performing small circular movements with the device. The devices are not adapted to massage the scalp, in particular because their fingers are not designed to pass through a person's hair.

The following documents are also known: EP-A1-1 803 368, EP-A1-1 839 521, DE-A1-199 54 450, FR-A1-2 769 806, FR-A1-2 889 919, FR-A1-2 661 077, GB-A- 2 159 045, JP-A-2004-350941, U.S. Pat. No. 5,116,253, GB-A-429 481, JP-A-5-285177, JP-A-10-146370, JP-A-8-198352, KR-A-2002-0015740, JP-A-11-104197, FR-A1-2 117 445, U.S. Pat. No. 6,006,395, GB-A-342 944, and KR-A-2002-0030040.

A particular object of the present invention is to provide a simple, effective, and economic solution to at least some of the above-mentioned problems of the prior art.

The invention provides a massage device of the spider type in which the pivoting of the fingers is defined in positive manner and can be reproduced identically many times.

To this end, the invention proposes a massage device, in particular for the scalp, comprising support means and massage fingers that are distributed on the support means and that are pivotally mounted via their proximal portions to the support means in such a manner that their distal ends move apart from one another when they are pressed against the scalp, said device being characterized in that the proximal portion of each finger is connected to the support means via hinge means that define at least one pivot axis for the finger, and in that the support means include pivot-limiter means for the fingers that define the most spaced-apart position for the distal ends of the fingers.

The massage device of the invention is particularly adapted to massaging the scalp, but it may be used to massage any skin surface.

The massage fingers may be distributed about an axis of the support means in such a manner that their distal ends move apart from one another in a substantially radial direction relative to the axis when they are pressed against the scalp.

In the present application, the term “hinge means” designates one or more elements connecting a finger to the support means, and enabling the finger to pivot relative to the support means.

The hinge means connect the proximal portions of the fingers directly to the support means and thus provide an assembly that is stronger than in the prior art. The hinge means define at least one pivot axis for each finger, e.g. an axis that is substantially tangential to a circumference centered on the above-mentioned axis of the support means, in such a manner that the distal end of each finger moves substantially radially relative to the axis of the support means in the particular configuration mentioned above. More precisely, the distal end of each finger moves by tracing a circular arc that is centered on the pivot axis of the finger, the circular arc being contained in a substantially radial plane that contains the axis of the support means. The hinge means may define a single pivot axis for each finger.

The axis of the support means may be its longitudinal axis or its axis of revolution when the support means include at least one surface of revolution. The axis of the support means may be in alignment with the axis of a dispenser opening of a container and/or with the longitudinal axis or axis of revolution of the container.

The pivot-limiter means for the fingers make it possible to limit the angular pivoting or spacing of the fingers. These means define an end of stroke of the fingers in positive manner, in which position the distal ends of the fingers are spaced as far apart as possible from one another. These means are advantageously independent of the hinge and/or guide means of the fingers. These means are advantageously formed by abutment means.

The fingers of the device may be arranged radially around the axis of the support means. In other words, the proximal ends of the fingers may lie on a circle. Where appropriate, the ends may be centered on the axis. The handle/manipulation member of the device may present a long axis about which the massage fingers are radially disposed. The handle may be formed by the body of the container.

The fingers of the device may be for pivoting in radial planes that are distributed around the axis of the support means. Preferably, the massage fingers are distributed regularly around the axis.

The number of massage fingers is at least 2 and preferably lies in the range 2 to 12, and more preferably lies in the range 6 to 10, e.g. 6. The fingers may have a shape that is rectilinear or curved a little. By way of example, the concave face may be oriented radially inwards.

The massage fingers may be rigid or semi-rigid so that they do not deform while the skin surface or the scalp is being massaged. In a variant, the fingers may be supple and/or flexible, e.g. elastically deformable. They may be made of a porous material for impregnating with a cosmetic, or they may even be covered in a layer of porous or cellular material. By way of example, the fingers are made of metal or of plastics material.

In the present application, the term “proximal portion of a finger” or “proximal end portion of a finger” means a portion of the finger that extends from the proximal end of the finger over a dimension corresponding to about 1/20 to ¼, e.g. ⅕, of the length or of the dimension of the finger extending along the axis of the support means. The hinge means may be formed on, or carried by, said portion, or they may extend said portion away from the fingers. By way of example, the hinge means may be of the fitted pin or pivot type, of the deformable thin film type, or of some other type. When the hinge means are of the pivot or pin type, the proximal portion of each finger may be fitted with, or may co-operate with, one or more pivots or pins, and when the hinge means are of the deformable thin film type for forming a film-hinge, one or more of the films may extend from the proximal portion of the finger, on the side remote from the finger, or may be formed at the proximal portion.

The support means advantageously include at least one cosmetic dispenser duct for being in fluid-flow communication with a container containing the cosmetic. The device may thus be used both to massage a skin surface and to apply a cosmetic to the surface, which is more economical and simpler than using two independent devices of the prior art.

The body of the container may be flexible so that light manual pressure on the body of the container enables a quantity of cosmetic to pass from the inside of the container to the dispenser duct.

In a variant, the body of the container may be rigid. The cosmetic may then pass into the dispenser duct naturally by gravity, or even by being forced by means of a pushbutton that is possibly mounted on a pump or a valve, which pump or valve may optionally meter out the cosmetic. The cosmetic may optionally be under pressure inside the container.

By way of example, the body of the container may be made of polyolefin, in particular of polypropylene or polyethylene.

The support means may include a fastener ring or sleeve for fastening on the neck of a container containing a cosmetic, the neck defining a dispenser opening for dispensing said cosmetic. The massage fingers of the device are situated beside the dispenser orifice of the container. Massaging and applying the cosmetic may thus be performed simultaneously.

The ring or the sleeve may be fastened on the neck of the container by screw-fastening, by crimping, or as a tight fit. The ring or the sleeve may be surmounted by a block or by a ring of resilient material, as described in greater detail below.

The dispenser duct may be connected to at least one orifice that opens out in the vicinity of the massage fingers and/or on said axis of the support means. The cosmetic then escapes from the duct at the proximal portions of the fingers.

In a variant, the dispenser duct is connected to one end of an internal channel of each finger, the other end of which channel opens out onto the distal end of the finger or in the vicinity of said end. The cosmetic thus escapes from the distal ends of the fingers, thereby making it possible to apply the cosmetic directly to the skin surface.

The fingers may include massage members and/or applicator members for applying cosmetic at their free or distal ends. The massage member of each finger may include at least one rotary ball, projecting studs, at least one bulge, etc. The massage member may be made of the same material as the finger or of a different material. The massage member may be arranged at a cosmetic dispenser orifice that opens out onto the finger, or on the contrary at a distance therefrom.

By way of example, each finger of the device may include an annular row of studs that extend around a cosmetic dispenser orifice that is situated at the distal end of the finger. Each cosmetic dispenser orifice may open out at a bulge that is situated at the distal end of a finger.

When the distal end of each finger carries a rotary ball, the ball may be mounted in a cavity of a spherical shape complementary to the shape of the ball, and formed at the distal end of the finger. In a variant, the ball is guided in rotation about the axis of a separate pin that may be fastened in corresponding orifices of the ball and of the distal end of the finger, or as defined by two diametrically-opposite lugs that are carried by the ball and that are engaged in cylindrical housings of complementary shape in the distal end of the finger.

By way of example, the fingers may be made of polypropylene.

In an embodiment of the invention, the hinge means of each finger comprise a pivot that is carried either by the support means and engaged in an orifice or bearing of complementary shape of the proximal portion of the finger, or else by the proximal portion of the finger and engaged in an orifice or bearing of complementary shape of the support means, so as to guide the finger in pivoting about the axis defined by the pivot. The pivots carried by the support means or by the fingers can be in the form of a shaft, a pin, a lug, etc. They may be fitted to, or formed integrally with, the support means or the fingers.

In a variant embodiment, the hinge means of each finger comprise a film or a film-hinge of material that is deformable, in particular in flexing, connecting the finger to the support means. The film is preferably elastically deformable. The film may be I-shaped and may, for example, extend in a plane that is substantially tangential to a circumference centered on the above-mentioned axis of the support means, and it is deformable in flexing about an axis that is also substantially tangential to the circumference. The film may also be substantially U-shaped or C-shaped having one end that is connected to the finger and having another end that is connected to the support means. The base or the mid-portion of the U-shaped or C-shaped film is deformable in flexing, in such a manner that the ends of the film can move apart from each another or towards each other.

The film may be fitted onto the finger and the support means (e.g. it may be made in the form of an adhesive label), or it may be made integrally with one or more fingers and possibly a portion of the support means (e.g. in the form of a film-hinge).

The support means may include a ring that is connected to the fingers via the films of deformable material, the ring, the films, and the fingers, preferably all being formed as a single piece. By way of example, the ring is made of polypropylene (PP). It may extend around the above-mentioned axis of the support means.

The support means may include a hoop that carries elastically-deformable tongues that bear against the fingers so as to urge them into a rest position in which their distal ends are close together. The tongues may be formed integrally with the hoop or they may be fitted and fastened thereon. By way of example, the tongues are made of PP.

In the rest position, the proximal portions of the fingers may be closer to the above-mentioned axis of the support means than their distal ends. The proximal portions of the fingers may be situated on a circumference centered on the axis, which circumference has a diameter that is smaller than the diameter of the circumference centered on the above-mentioned axis and passing via the distal ends of the fingers. This enables the fingers to pivot outwards, and, at their distal ends, move apart from one another, when the device is moved towards the skin surface and the distal ends of the fingers slide over said surface.

The support means may include openings that are substantially radial, and through which the fingers pass and move. The openings may be formed in the above-mentioned hoop. Each tongue of the hoop may be housed, at least in part, in one of the openings. The ring may thus be engaged inside the hoop by aligning the ring and the hoop on the same axis, then by moving the ring towards the hoop in a direction that is parallel to their axes, until the fingers of the ring pass through the above-mentioned openings of the hoop.

The pivot-limiter means for the fingers may be formed by abutment means for the fingers, which abutment means are preferably carried by an annular collar that extends around the proximal portions of the fingers. Contrary to the prior art, the end of pivot stroke of the fingers is defined in positive manner by first abutment means. In this position, each finger may form an angle with the axis of the support means that lies in the range about 30° to 80°.

The support means (e.g. the above-mentioned ring and/or the hoop) may include second abutment means against which the fingers may come into abutment so as to define a closest-together position for the distal ends of the fingers. The angular travel of the fingers is thus defined in positive manner by the first and second abutment means. By way of example, the angular travel lies in the range about 20° to 80°.

The device of the invention may include two to twelve, and preferably six to ten, massage fingers distributed on the support means, e.g. around the axis of the support means.

Resilient return means, preferably independent of the support means, may co-operate with the fingers so as to urge them from their spaced-apart position to their close-together position. The resilient return means may comprise an elastically-deformable ring that is mounted around the fingers and that bears against said fingers. The ring may be mounted radially outside the fingers relative to the axis of the support means. Even if the resilient ring breaks, the fingers are held to the support means by the above-mentioned hinge means.

The pivot-limiter means for the fingers may be formed by tongues that are flexible or elastically deformable and that extend between the support means and the fingers, the pivoting of the fingers causing the tongues to deform, and the deformation capacity of the tongues defining the pivot amplitude of the fingers. Each of the tongues is preferably substantially U-shaped in its unstressed state, and includes one end that is connected to one of the fingers, and an opposite end that is connected to the support means, the ends moving apart from each other while the finger is pivoting. Each finger may be connected to one or two tongues.

Advantageously, the fingers, the tongues, and the support means are formed as a single piece.

In a particular embodiment of the invention, the fingers are connected at their proximal ends to an annular crown that is subdivided into sectors, each crown sector being connected to the support means via one or more tongues of the above-mentioned type and via the finger hinge means.

In still another variant embodiment, the support means of the device include at least a resilient block or strip of elastically-deformable material that is arranged at the proximal ends of the fingers and that is for forming hinge means for the fingers, pivot-limiter means for the fingers, and/or resilient return means for returning the fingers into their close-together position.

This strip of elastically-deformable material may be of annular shape, and it may extend around the proximal ends of the fingers, so as to limit the degree to which the fingers can pivot outwards, and so as to urge the fingers into their close-together position. In a variant, the proximal ends of the fingers are embedded in the material of the strip that thus forms hinge means for the fingers.

The strip of elastically-deformable material includes orifices that form through holes through which cosmetic passes and/or blind holes in which massage fingers are mounted. Internally, the massage fingers may define dispenser channels for dispensing the cosmetic.

The strip of material may be made by being molded onto the ring or the sleeve of the support means. It can also be fastened on the ring or the sleeve by adhesive, by resilient snap-fastening, by dual-injection, by interfitting, etc.

Material that is suitable for being used to make the strip of material may, for example, be selected from: cured or thermoplastic elastomers, in particular ethylene-propylene terpolymer rubber (EPDM), styrene-ethylene-butylene-styrene (SEBS), thermoplastic polyurethane (TPU); natural rubbers; nitrile rubber, butyl rubber, or silicone rubber elastomers.

The device of the invention may further include a stand-forming lid or cap. The cap may have a cylindrical shape for surrounding all of the fingers and for resiliently snap-fastening on the support means. In a variant, the cap includes a face that rests on a support, and an opposite face that presents blind holes for housing the distal ends of the fingers.

The present invention also seeks to obtain a device that provides high-performance massaging in such a manner as to obtain lymphatic drainage that is sufficient to enable good penetration of a cosmetic for dispensing on the body surface being massaged. In particular, the present invention seeks to enable the cosmetic to be released in simple and rapid manner, and in sufficient quantity, onto said massaged body in order to benefit from the effects of lymphatic drainage, thereby enabling good penetration of the cosmetic into the skin.

The present invention also relates to a cosmetic container including a dispenser opening for dispensing a cosmetic, said container being characterized in that a massage device as described above is mounted on the container, at its dispenser opening.

When the container is fitted with a dispenser system of the pump, valve, or similar type, the device of the invention is advantageously mounted on the dispenser system in such a manner as to form a pushbutton, the device thus being pressed so as to actuate the pump or the valve and thus cause the cosmetic to be released onto the scalp or the skin surface.

The dispenser system may be actuated by exerting manual pressure on the device, e.g. in a direction that is parallel to the above-mentioned axis of the support means.

The first abutment means of the support means preferably form a bearing surface for actuating the dispenser system. When the fingers are in their most spaced-apart position and bear against the first abutment means of the support means, it suffices to exert additional force on the fingers, by pressing their distal ends against the scalp or the skin surface, so as to urge the support means to move relative to the container, and thus actuate the dispenser system and release the cosmetic. The first abutment means may be carried by the above-mentioned hoop of the support means, the hoop possibly being secured to the above-mentioned ring. In this event, it is the entire massage device, namely the ring carrying the fingers and the hoop carrying the first abutment means, that forms a pushbutton.

The invention also provides a massage and applicator device for applying a cosmetic, the device comprising support means and massage fingers that are distributed on the support means and that are pivotally mounted via their proximal portions to the support means in such a manner that their distal ends move apart from one another when they are pressed against the scalp, said device being characterized in that the support means include at least one cosmetic dispenser duct, the duct being in fluid-flow communication with a container containing the cosmetic.

The dispenser duct of the support means may open out at the base or at the proximal portions of the fingers, or it may be connected to internal channels of the fingers that extend over all or part of the length or the dimension of the fingers extending along the axis of the support means.

The invention finally provides a massage device, in particular for the scalp, comprising support means and massage fingers that are distributed on the support means and that are pivotally mounted via their proximal portions to the support means in such a manner that their distal ends move apart from one another substantially radially relative to said axis of the support means when they are pressed against the scalp, said device being characterized in that the proximal portion of each finger is connected to the support means via hinge means that define a respective single pivot axis for the finger.

The two above-mentioned devices may include all or some of the characteristics mentioned above with reference to the massage device having support means that include first abutment means for the fingers.

The invention can be better understood and other details, characteristics, and advantages of the present invention appear more clearly on reading the following description given by way of non-limiting example and with reference to the accompanying drawings, in which:

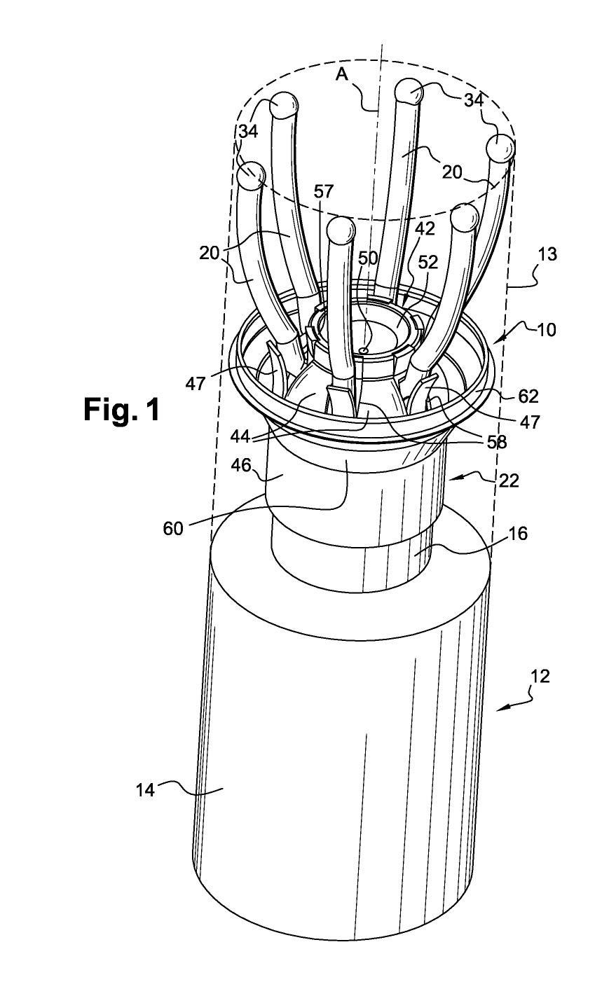

FIG. 1 is a diagrammatic perspective view of a massage device of the invention, mounted on a container containing a cosmetic;

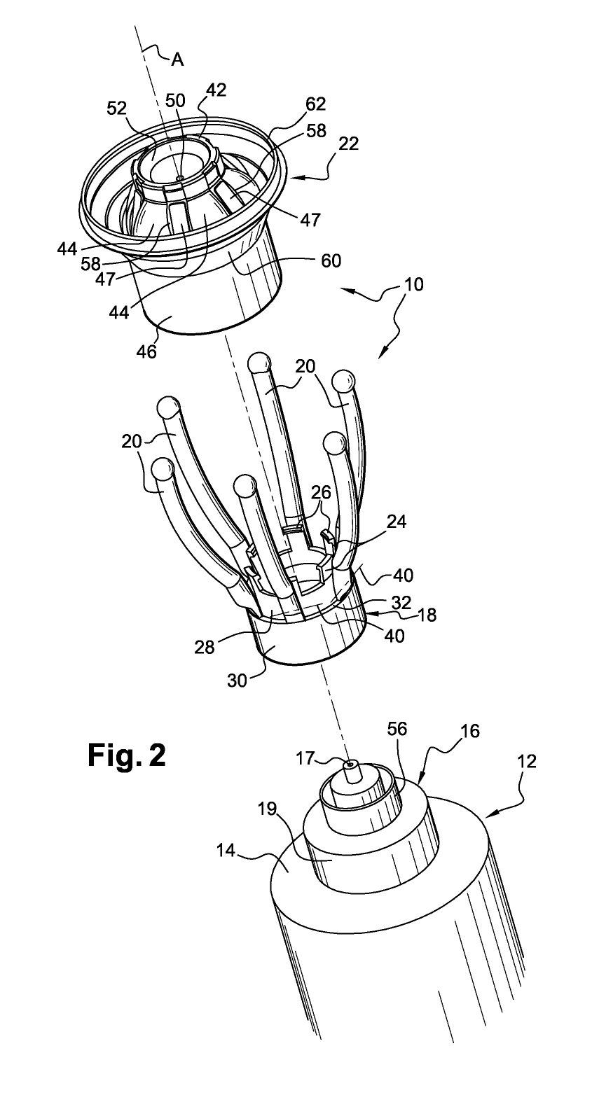

FIG. 2 is a diagrammatic and fragmentary exploded perspective view of the FIG. 1 massage device and container;

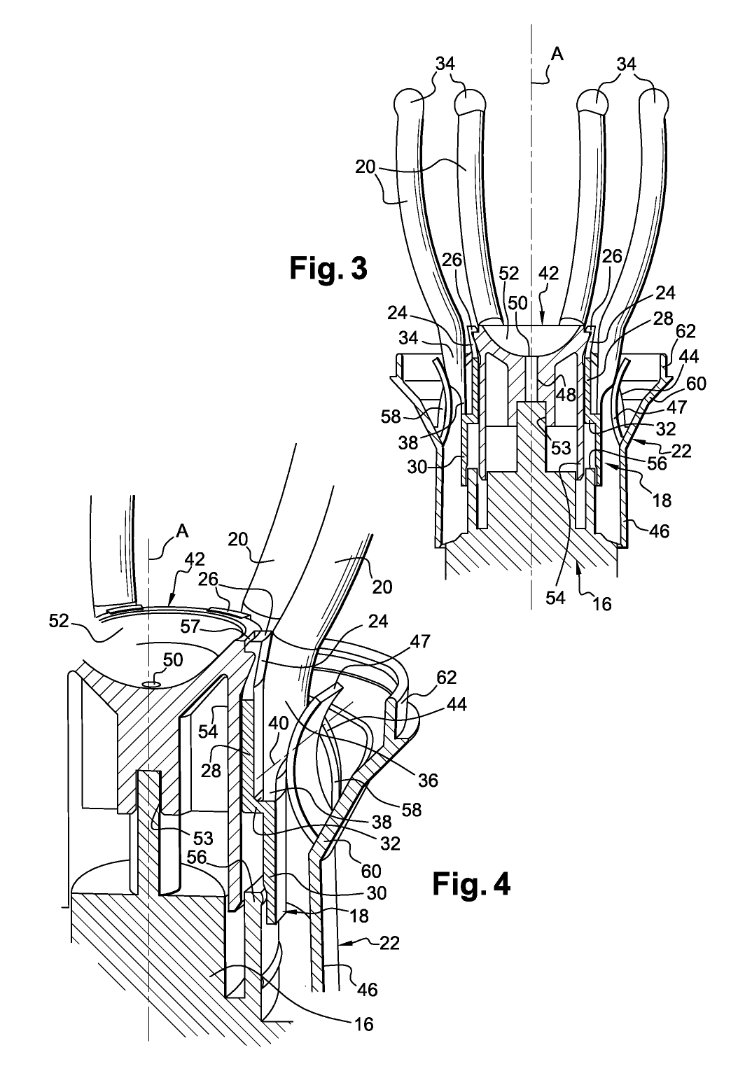

FIG. 3 is a diagrammatic view in axial section of the FIG. 1 device, and shows the massage fingers of the device in a close-together position;

FIG. 4 is a diagrammatic and fragmentary perspective view in section of the FIG. 1 massage device, the massage fingers being in their close-together position;

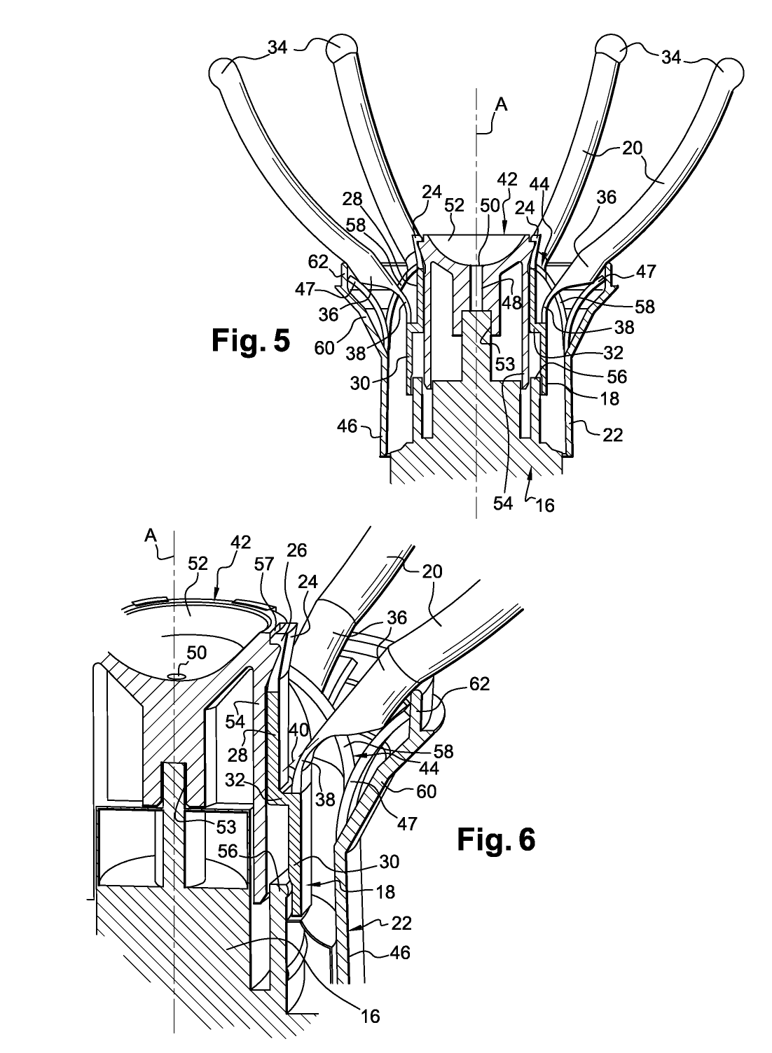

FIG. 5 is a diagrammatic view in axial section of the FIG. 1 device, and shows the massage fingers of the device in a spaced-apart position;

FIG. 6 is a diagrammatic and fragmentary perspective view in section of the FIG. 1 massage device, the massage fingers being in their spaced-apart position;

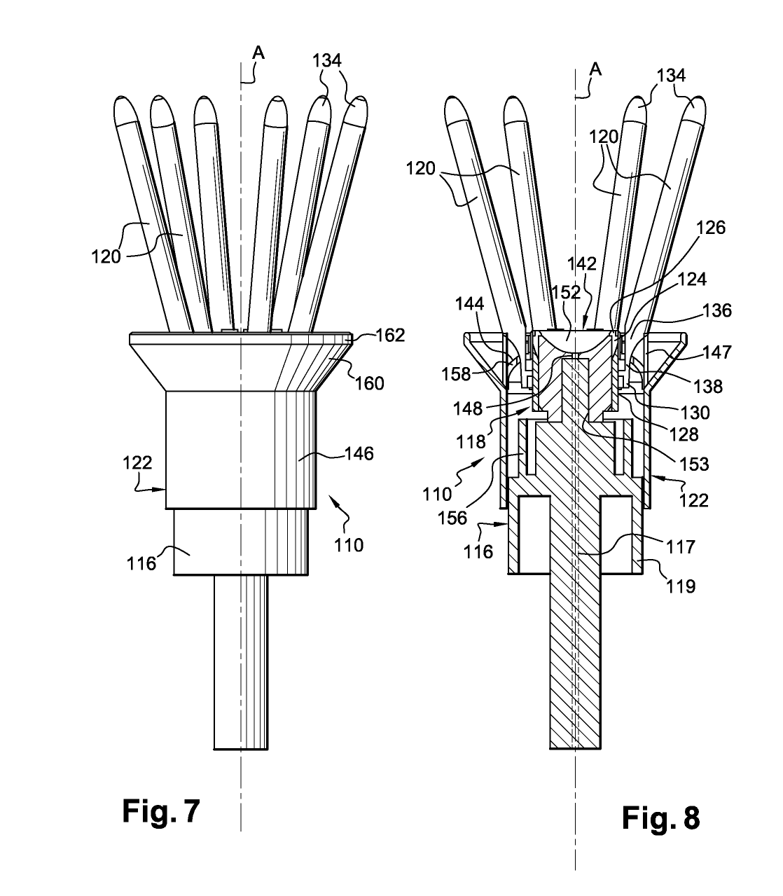

FIG. 7 is a diagrammatic side view of a variant embodiment of the massage device of the invention;

FIG. 8 is a diagrammatic view in axial section of the FIG. 7 device;

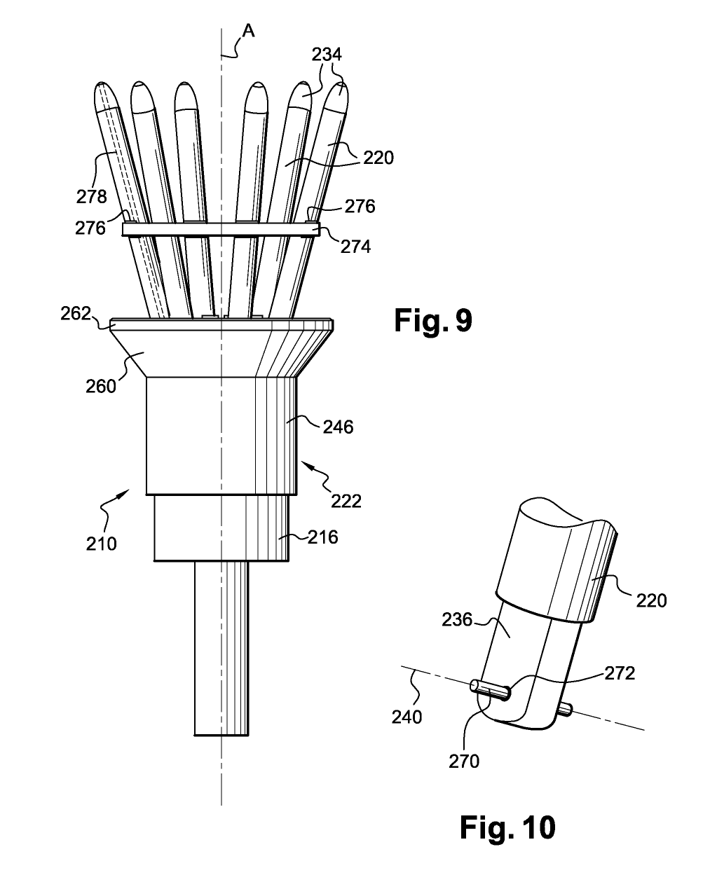

FIG. 9 is a diagrammatic side view of another variant embodiment of the massage device of the invention;

FIG. 10 is a diagrammatic and fragmentary perspective view of an example of hinge means for a massage finger of the device of the invention;

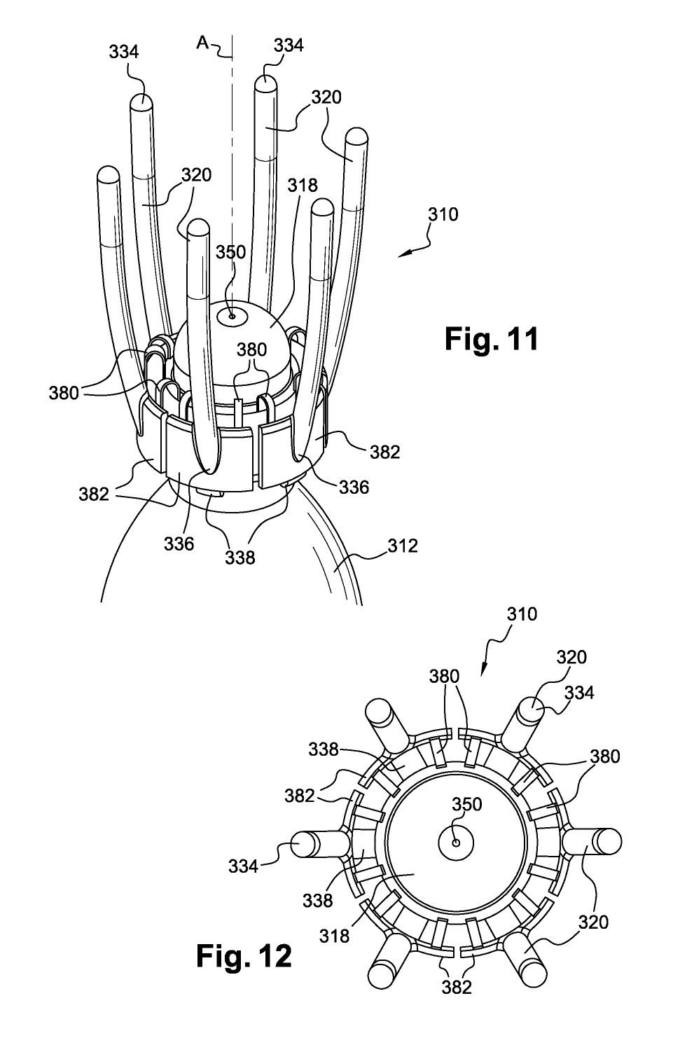

FIG. 11 is a diagrammatic perspective view of another variant embodiment of the massage device of the invention;

FIG. 12 is a diagrammatic plan view of the FIG. 11 massage device;

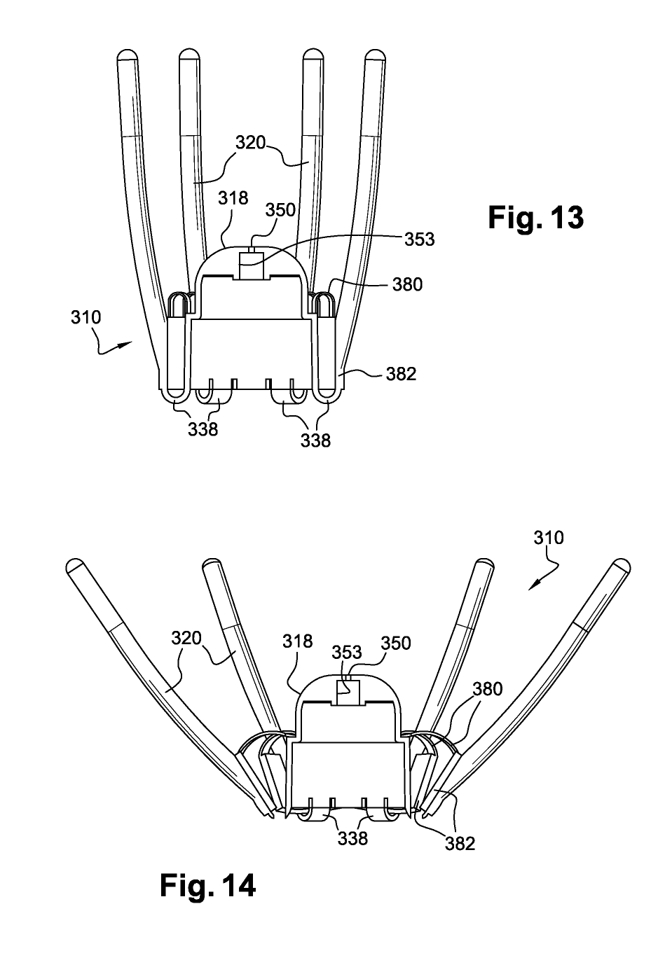

FIGS. 13 and 14 are diagrammatic views in axial section of the FIG. 11 massage device, the massage fingers of the device being in their close-together and spaced-apart positions respectively;

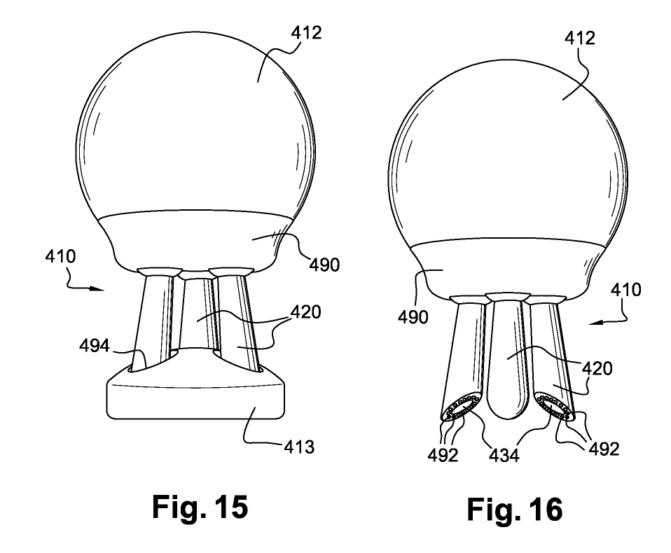

FIGS. 15 and 16 are diagrammatic perspective views of another variant embodiment of the device of the invention, the device being placed on a stand in FIG. 15;

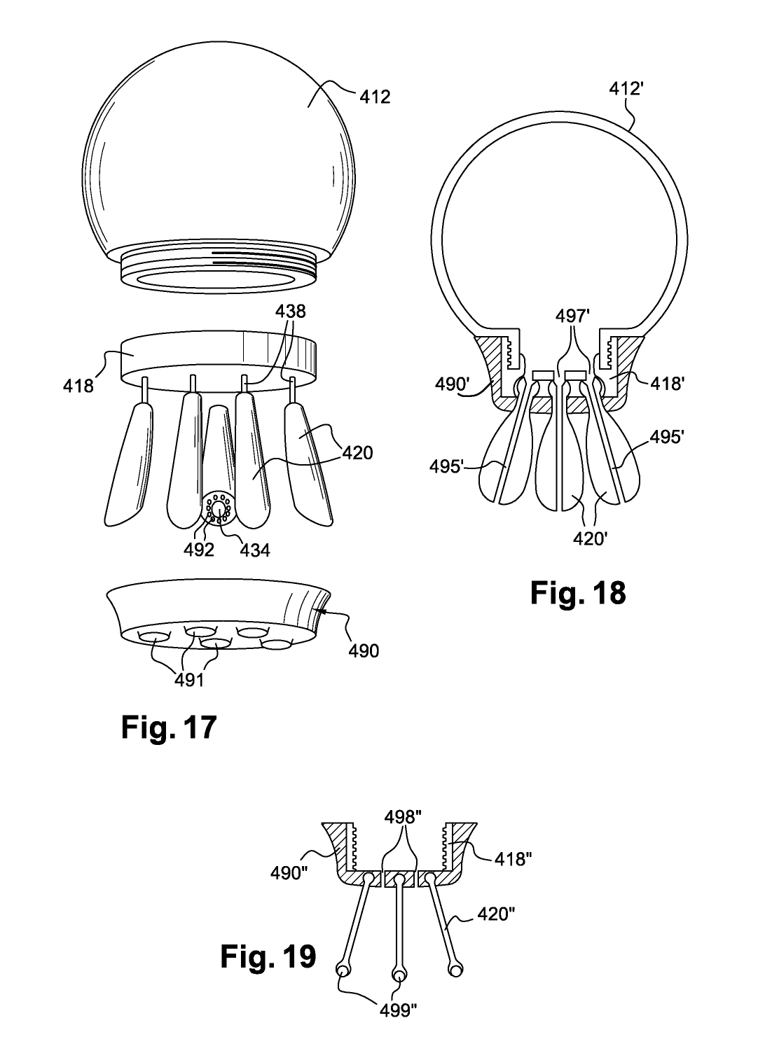

FIG. 17 is a diagrammatic exploded perspective view of the device in FIGS. 15 and 16; and

FIGS. 18 and 19 are diagrammatic views in axial section of variant embodiments of the hinge and pivot-limiter means for the fingers of the device in FIGS. 15 and 16.

Reference is made firstly to FIGS. 1 to 6 that show a device 10 of the invention for massaging a skin surface, in particular the scalp, and for applying a cosmetic to the skin surface, the device 10 being mounted on a container 12 containing the cosmetic.

The device 10 may be used before or after the cosmetic has been deposited on the skin surface in order to massage and relax the surface, or it may be used simultaneously with depositing the cosmetic on the skin surface.

In the embodiment shown, that is non-limiting, the container 12 comprises a body 14 having an elongate cylindrical shape of longitudinal axis A, and carrying, at its top end, a neck (not shown) on which the massage device 10 is fastened, the neck defining an opening for filling the container and for dispensing a cosmetic. The longitudinal axis A of the container passes substantially through the middle of the opening of the container.

The device 10 can be mounted on the neck of the container 12 by means of a dispenser system 16 of the pump or valve type, for example. The system 16 can include an internal longitudinal channel 17 (FIG. 2) having a top end that is connected to the device 10 in order to supply it with cosmetic, and a bottom end that opens out inside the container 12. The neck of the container 12 can present a thread for co-operating with a corresponding thread of a ring 19 of the system 16 for fastening the system on the container. In a variant, the dispenser system 16 can be mounted by force-fitting, snap-fastening, crimping, or rolling onto the neck of the container 12.

A protective cap 13 (FIG. 1) can possibly be fastened in removable manner on the container while it is being carried or stored so as to protect the fingers 20, in particular from dust. By way of example, the cap 13 is of cylindrical shape and extends along the axis A around the system and the device 10 (FIG. 1).

In known manner, when the cosmetic is under pressure inside the container 12, the system 16 can be fitted with a valve that is actuated by pressing on the top end of the system 16 in a direction that is substantially parallel to the axis A, so as to cause the cosmetic to pass through the channel 17. When the cosmetic is not under pressure in the container 12, the system 16 can include a pump that is also actuated by pressing on the top end of the system in a direction that is parallel to the axis A, so as to cause the cosmetic to pass through the channel 17. The device 10 of the invention advantageously forms a pushbutton for actuating the pump or the valve of the dispenser system, as described in greater detail below. In a variant, the cosmetic can flow by gravity into the internal channel 17 of the system 16 from the container to the massage device 10, merely by turning the device upsidedown. When the container is compressible, manual pressure on the body of the container can force the cosmetic to pass through the channel 17 of the system 16.

The cosmetic can be a treatment or care product, such as a hair-treatment lotion (anti-hairloss, anti-dandruff, shampoo, conditioner), hair coloring, a styling product (gel, hairspray), a massage product (anti-cellulite, slimming, massage oil, moisturizer), etc.

In the example shown, the massage device 10 comprises two parts: a ring 18 carrying massage fingers 20, and a hoop 22 that surrounds the ring coaxially.

At its top end, the ring 18 includes flexible fastener tabs 24 for fastening to the hoop 22 by resilient snap-fastening. The tabs 24 extend parallel to the longitudinal axis A, and, at its top free end, each tab carries a hook-forming rim 26 that is oriented radially inwards relative to the axis A.

The tabs 24 are distributed regularly around the axis A. By way of example, they can be six in number. They can be formed on the ring 18 by cutting into the top end portion thereof.

The ring 18 further includes two cylindrical walls 28, 30 about the same axis, being disposed one above the other. The walls 28, 30 have different diameters, the wall 28 of smaller diameter being situated above the wall 30 of greater diameter. The tabs extend axially upwards from the top end of the top cylindrical wall 28. The bottom end of the top wall 28 is connected via a transverse annular wall 32 to the top end of the bottom cylindrical wall 30.

The massage fingers 20 have a shape that is elongate and that is curved a little in the embodiment shown, the concave face of each finger being oriented radially inwards relative to the axis A. The fingers 20 are distributed regularly around the axis A and are six in number in the embodiment shown. In this embodiment, they are aligned radially with the flexible tabs 24.

The fingers 20 extend along the axis A over a length or dimension lying in the range about 20 millimeters (mm) to 120 mm. In cross-section, they can present a substantially circular shape of diameter lying in the range about 2 mm to 15 mm.

Each of the free or distal ends 34 of the fingers 20 include a bulge defining a bearing surface for bearing against the scalp. The proximal portion 36 of each finger is connected to the ring 18 via a film-hinge corresponding to a local narrowing of material or via a fitted label of elastically-deformable material, so as to form a film 38 or a flexible hinge.

In the embodiment shown, each finger 20 is connected to the ring 18 via a film 38 that extends parallel to the axis A from its bottom end connected to the top end of the bottom wall 30 of the ring, to its top end connected to the end or the proximal portion 36 of the finger. In its unstressed state or at rest, each film 38 extends substantially parallel to the top wall 28 of the ring, extending the bottom wall 30 of the ring (FIGS. 3 and 4).

By way of example, each film 38 is substantially rectangular in shape with a thickness or radial dimension that lies in the range about 0.3 mm to 3 mm, a width or circumferential dimension that lies in the range about 2 mm to 15 mm, and a length or axial dimension that lies in the range about 1 mm to 15 mm.

Each film 38 is deformable in flexing about an axis 40 that is substantially tangential to a circumference centered on the axis A, in such a manner that each finger can pivot about the axis 40 (FIGS. 2, 4, and 6).

In the rest position shown in FIGS. 1, 3, and 4, the distal ends 34 of the fingers are spaced-apart radially from one another and are situated on a circumference centered on the axis A having a diameter D (e.g. lying in the range about 30 mm to 80 mm) that is greater than the diameter d (e.g. lying in the range about 5 mm to 30 mm) of the circumference passing via the proximal ends of the fingers. In this position, the proximal portions 36 of the fingers are spaced radially apart from the top wall 28 and the flexible tabs 24 of the ring 18. In this position, each finger 20 forms an angle with the axis A that lies in the range about 5° to 40°.

Each finger 20 is pivotable about the axis 40 from its rest position to the most spaced-apart position shown in FIGS. 5 and 6, in which the finger forms an angle with the axis A that lies in the range 30° to 80°. This most spaced-apart position is defined by the proximal end portions of the fingers 20 being in abutment against an element of the hoop 22 that is described in greater detail below. In this position, the distal ends 34 of the fingers are situated on a circumference centered on the axis A having a diameter that lies in the range about 40 mm to 120 mm.

Each finger 20 is also pivotable about the axis 40 from its rest position in FIGS. 3 and 4 to a closest-together position, in which the proximal end portions 36 of the fingers are in abutment against the top wall 28 and/or the tabs 24 of the ring 18. In this position, the distal ends 34 of the fingers are situated on a circumference centered on the axis A having a diameter that lies in the range about 5 mm to 60 mm, and each finger forms an angle with the axis A that lies in the range about 0 to 30°.

In the embodiment shown, the ring 18, the flexible tabs 24, the films 38, and the fingers 20 are formed as a single piece. By way of example, they are made of PP.

The hoop 22 includes an inner cylindrical sleeve 42 that is connected via an annular wall 44 to an outer cylindrical wall 46 surrounding the sleeve 42, the hoop 22 further carrying elastically-deformable tongues 47 for urging the fingers 20 of the ring into their rest position.

The sleeve 42 is engaged axially on the top end of the system 16, and includes, at its top end, a dish 52 at the bottom of which there is formed a dispenser orifice 50 for dispensing a cosmetic.

The bottom end of the sleeve 42 includes an axial cylindrical borehole 53 in which the top end of the system 16 is engaged. The sleeve 42 includes an internal longitudinal duct 48 that provides fluid-flow communication between the internal channel 17 of the system 16 and the dispenser orifice 50.

The sleeve 42 includes an outer cylindrical wall 54 for being surrounded by the ring 18. The top wall 28 of the ring 18 surrounds the top end portion of the wall 54 substantially without clearance, and its bottom wall 30 co-operates with the bottom end portion of the wall 54 to define an annular space of axis A in which a complementary-shaped cylindrical wall 56 of the system 16 is engaged and can slide in axial translation.

At its top end, the cylindrical wall 54 of the sleeve 42 includes radial notches 57 for resiliently snap-fastening the rims 26 of the flexible tabs 24 of the ring 18. The notches 57 are distributed regularly around the axis A and are 6 in number in the embodiment shown.

Each of them has an angular extent around the axis A that is substantially equal to the angular extent of one of the flexible tabs 24.

The top end of the wall 54 of the sleeve 42 is connected to the inner periphery of the annular wall 44 that has a slightly convex shape, having a convex face that is oriented radially upwards and outwards.

The annular wall 44 includes a plurality of substantially-radial openings 58 through which the fingers 20 of the ring pass, and in which the fingers can move radially.

The number of such openings 58 is equal to the number of fingers, and is thus equal to six in the embodiment shown. The openings 58 extend over substantially all of the radial dimension of the annular wall 44, in such a manner that the wall is divided by the openings 58 into a plurality of sectors distributed around the axis A. They are designed to be passed through by the flexible tabs 24 of the ring 18 that fasten to the top end of the sleeve 42 (FIG. 1). The longitudinal edges of the openings 58 can provide guidance for the fingers 20 while they are pivoting.

The outer periphery of the annular wall 44 is connected to the top end of the outer cylindrical wall 46 of the sleeve for surrounding the wall of the ring 18 and the system 16.

The top end of the cylindrical wall 46 is connected to a frustoconical collar 60 that flares upwards and that extends around the wall 28 of the ring, the annular wall 44, and the proximal end portions 36 of the fingers 20.

The collar 60 includes pivot-limiter means for the fingers, which means form an abutment against which the proximal end portions 36 of the fingers can come to bear so as to define the most spaced-apart position of the fingers (FIGS. 5 and 6). In this embodiment, the abutment means are formed by a cylindrical rib 62 that extends upwards from the greatest diameter, top end of the collar 60. The rib 62 can extend in discrete or continuous manner as in the embodiment shown.

An elastically-deformable tongue 47 extends in each opening 58 of the wall 44 of the hoop and bears against the proximal end portion 36 of the finger that passes through the opening, so as to urge the finger radially inwards.

Each tongue 47 has a general shape that is circularly arcuate, having a concave face that is oriented radially outwards. It extends upwards from its bottom end that is connected to the top end of the outer cylindrical wall 46 of the hoop. Its outer surface faces the collar 60 and the proximal end portion of the finger 20 comes to bear against its inside surface.

In the unstressed or rest state, the tongue 47 bears against the finger 20, as shown in FIGS. 3 and 4. When a force is exerted on the finger 20 so as to move it outwards, the tongue 47 deforms elastically and slides over the pivoting finger. When the force is relaxed, the tongue 47 bears against the finger 20 and applies a return force thereon that is sufficient to return the finger to its rest position.

In the embodiment shown, the sleeve 42, the walls 44 and 46, and the tabs 47 of the hoop 22 are formed as a single piece. By way of example, they are made of PP.

The massage device 10 is assembled in the following way: the ring 18 is aligned on the axis of the hoop 22 in such a manner that the fingers 20 are situated beside the hoop and are aligned axially with the openings 58 thereof (FIG. 2). The ring 18 is thus moved axially towards the hoop and is engaged therein until the fingers 20 pass through the openings 58 of the hoop, and the tabs 24 become engaged by resiliently snap-fastening in the notches 57 of the hoop. The device 10 is thus mounted on the system 16 that has already been mounted on the container neck 12. To do this, the device 10 is moved axially towards the system 16 until the top end of the system 16 is engaged in the axial borehole 53 of the sleeve 42, and the cylindrical wall 56 of the system 16 is engaged in the annular space defined by the ring 18 and the sleeve 42. The device is thus ready to be used, e.g. in the following way:

The user takes hold of the body of the container 12 and applies the distal ends 34 of the fingers 20 of the device 10 against the scalp. The user moves the container 12 in one direction and then in another parallel to the axis A and approximately perpendicular to the scalp, in such a manner that the fingers 20 pivot about their respective axes 40 and their distal ends 34 move apart from one another and then towards one another, sliding over the scalp.

When the dispenser system 16 is fitted merely with a flap valve, the user can compress the body 14 of the container by exerting pressure on the body in a direction that is substantially orthogonal to the axis A, with a view to dispensing the cosmetic. The cosmetic thus passes through the channel 17 of the system 16 and through the duct 48 of the sleeve 42 to escape via the dispenser orifice 50.

When the system 16 is fitted with a pump or a valve mechanism, the massage device itself forms a pushbutton and the user can apply a small amount of pressure on the device in a direction that is parallel to the axis A so that the cosmetic is dispensed with a view to being applied to the scalp.

The device 10 is then mounted to slide along the axis A on the system 16, and the cylindrical wall 56 or the fastener ring 19 of the system 16 can form a guide cylinder during said sliding.

In order to actuate the system 16 by means of the pushbutton, the user can urge the fingers 20 into their most spaced-apart position in which they come into abutment against the rib 62 of the hoop 22. The bearing force exerted by the fingers 20 against the scalp is thus transferred to the hoop (and thus to the massage device 10 as a whole, since the ring 18 and the hoop 22 are secured together). The massage device thus slides relative to the container 12 and in particular relative to the fastener ring 19 of the dispenser system 16, thereby causing the dispenser system to be actuated and the cosmetic to be released.

In a variant and by way of example, the user can press directly by means of one or more fingers against the rib 62 of the hoop 22 in order to actuate the dispenser system 16.

FIGS. 7 and 8 show a variant embodiment of the device 110 of the invention in which the elements described above are referenced by the same numbers plus one hundred. This principle of adding another hundred to reference numbers is continued with the subsequent embodiments.

The device 110 differs from the above-described device in particular in that the fingers 120 are of shape that is elongate and rectilinear. They extend upwards and outwards along the axis A. In the rest position, each finger forms an angle with the axis A that lies in the range about 10° to 40°.

The distal ends 134 of the fingers 120 are frustoconical or tapered, so as to reduce the areas of the bearing surface of the fingers against the scalp. The proximal portion 136 of each finger is connected to the ring 118 via a film 138 of elastically-deformable material that is similar to that described above. The ring 118 includes tabs 124 that are provided with hooks 126 of the above-mentioned type, for fastening the ring on the hoop 122 by resilient snap-fastening.

In the unstressed state, the elastically-deformable tongues 147 that are carried by the hoop 122 are substantially rectilinear and extend substantially parallel to the axis A. At their top free ends, they bear against the proximal portions 136 of the fingers, so as to urge them into their rest position.

Assembling and using the device 110 is similar to assembling and using the device 10 in FIGS. 1 to 6.

The variant embodiment shown in FIGS. 9 and 10 differs from the variant embodiment in FIGS. 7 and 8 in that each finger 220 is pivotally mounted on the ring 218 or the hoop 222 by means of a fitted hinge, and in particular a fitted pin hinge, or more generally a pivot connection piece. The hinge can comprise a cylindrical pivot 270 that is carried by the ring or the hoop and that is housed in a corresponding cylindrical orifice 272 of the proximal portion 236 of the finger (FIG. 10). The pivot defines the pivot axis 240 for the finger 220, which pivot axis is substantially tangential to a circumference centered on the axis A, in such a manner that the finger pivots radially relative to the axis A. The free ends of the pivot 270 are centered and guided in turning in corresponding housings of the ring or of the hoop.

In this embodiment, the fingers 220 are urged into their rest position by elastically-deformable means that are independent of the hoop 222 and of the ring, and of the support means in general. These means are formed by a resilient ring 274 that extends around the fingers 220 and that bears against mid-portions thereof. At its mid-portion and on its outside, each finger 220 includes a transverse groove 276 into which the ring 274 passes and is retained axially.

Each finger 220 can further include an internal channel 278 through which cosmetic passes. At its bottom end, the channel 278 can be connected to the internal duct 248 of the sleeve or to the internal channel 217 of the system 216. The top end of the channel 278 of each finger 220 can open out onto the distal end 234 of the finger, so as to deposit the cosmetic directly on the scalp while the scalp is being massaged.

The device 220 is used in identical manner to the above-described devices 10, 110.

FIGS. 11 to 14 show another variant embodiment of the device 310 of the invention, which device differs from the device in FIGS. 1 to 6 essentially in that it is formed as a single piece, the pivot-limiter means for the fingers, defining the most spaced-apart position (FIG. 14) and the closest-together position (FIG. 13) of the fingers 320, being formed by elastically-deformable tongues 380 that connect the fingers to the support ring 318 of the device.

In this embodiment, the fingers 320 are connected via their proximal ends 336 to an annular crown 382 that is subdivided into sectors and that extends around the ring 318, each crown sector carrying a finger and being connected to the ring via the above-mentioned tongues 380 and via films 338 that are similar to the above-described films 38.

Each film 338 extends between the bottom circumferential edge of a crown sector 382 and the ring 318, and has a curved U-shape or C-shape having a concave face that is oriented upwards. Each tongue 380 extends between the top circumferential edge of a crown sector 382 and the ring 318, and has a curved U-shape or C-shape having a concave face that is oriented downwards.

The tongues 380 and the films 338 are distributed regularly around the axis A.

In the embodiment shown, the number of tongues 380 is equal to twice the number of films 338 or the number of fingers 320, and each finger 320 is connected to the ring 318 via a film 338 and two tongues 380. The tongues 380 are also thinner than the films.

The tongues 380 are flexible or elastically deformable between a position shown in FIGS. 11 to 13 in which their ends are close together and each crown sector 382 extends substantially parallel to the axis A, and a position shown in FIG. 14 in which their ends are at a distance from one another and each crown sector 382 slopes by a given angle relative to the axis A. The deformation capacity of the tongues 380 defines the pivot amplitude of the fingers 320. When the tongues 380 are in their fully stretched position (FIG. 14), they define the most spaced-apart position of the distal ends of the fingers 320.

The films 338 are elastically deformable and urge the fingers 320 into their rest position. The films 338 thus form both hinge means for the fingers and resilient return means for returning the fingers into their rest position.

In this embodiment, the top end of the ring 318 includes a convex surface, at the center of which a cosmetic dispenser orifice 350 opens out. The ring 316 includes an axial cylindrical borehole 353 that communicates with the orifice 350, and in which there is engaged the top end of a dispenser system of the above-mentioned type that is mounted on the neck of a container 312.

In the variant embodiment in FIGS. 15 to 17, the device 410 differs from the above-described devices in particular in that it includes a block 490 of elastically-deformable material that includes orifices 491 through which fingers 420 pass.

In this embodiment, the proximal ends of the fingers 420 are connected by elastically-deformable films 438 of the above-mentioned type to a support ring 418 that is screw-fastened on the neck of the container 412. In a variant, the finger support-ring 418 is fastened by resilient snap-fastening on the neck of the container.

The films 438 form hinge means for the fingers 420. In this embodiment, the block of material 490 extends around the proximal ends of the fingers 420, forming means that limit the degree to which the fingers can pivot outwards, and that urge the fingers into a position that is close to the rest position.

The block 490 is mounted on the ring 418 by being moved axially towards the ring in such a manner that the fingers 420 pass through the orifices 491 until the block surrounds the ring, and also the films 438, and the proximal ends of the fingers.

The block 490 is fastened on the ring 418 by adhesive or by resilient snap-fastening. In a variant, the block 490 may be molded onto the ring 418. By way of example, the block 490 may be made of an elastomer.

In yet another variant, the support ring, the block, and the fingers are formed as a single piece of a resilient material. Alternatively the fingers may be formed integrally with separate support means that are fastened on the above-mentioned ring by means of the block of resilient material.

In this embodiment, the fingers 420 have a shape that is substantially frustoconical, with their distal ends being the ends of greatest section. Each finger 420 includes an internal duct through which cosmetic passes, the duct being connected at one end to the internal volume of the container, and opening out at its other end into a setback 434 in the distal end of the finger. In this embodiment, each finger 420 includes an annular row of massage studs 492 that project and extend around the above-mentioned setback 434 of the finger.

The device 410 may further include at least one cosmetic dispenser orifice in the vicinity of the proximal ends of the fingers 420, the orifice being formed in the block 490 of resilient material and being in fluid-flow communication with the above-mentioned volume via at least one orifice of the ring 418.

The body of the container 412 can be made of a flexible material and can be compressed manually so as to force the cosmetic from the above-mentioned volume to the dispenser orifices of the fingers 420 and of the block 490. In a variant, the body of the container 412 can be made of a rigid material and the ring 418 can form an actuating member enable to actuate a distributing member such as a pump, a valve or an airless-type system (i.e., a system without air return such as a provided with a follow-up piston).

The device 410 further includes a cap 413 (FIG. 15) that forms a stand in this embodiment. The cap 413 has a general circular shape and includes a plane face resting on a support, and an opposite face that is convex in shape and includes blind holes 494 for housing the distal ends of the fingers 420.

In the variant embodiment in FIG. 18, the proximal end of each finger 420′ is connected via a ball joint to the support ring 418′ that is screw-fastened on the neck of the container 412′. The hinge means for the fingers 420′ are therefore carried by the ring 418′. The block 490′ of resilient material extends around the ring 418′ and includes orifices through which the fingers 420′ pass, the block of material 490′ forming means that limit the degree to which the fingers can pivot, and that urge the fingers into their close-together position.

As in the embodiment in FIGS. 15 and 16, the fingers 420′ include internal ducts 495′ through which cosmetic passes, which ducts open out at the distal ends of the fingers, and are in fluid-flow communication with the internal volume of the container 412′ via orifices 497′ in the ring.

In the variant in FIG. 19, the proximal ends of the fingers 420″ are fastened directly in the block 490″ of resilient material that forms hinge and pivot-limiter means for the fingers. In this embodiment, the block 490″ is molded onto the proximal ends of the fingers and on the ring 418″ for screw-fastening on the neck of the container.

In this embodiment, the block 490″ includes cosmetic dispenser orifices 498″ that are in fluid-flow communication with the internal volume of the container. In this embodiment, the distal ends of the fingers 420″ carry rotary massage balls 499″.

The massage device of the invention can include a number of fingers that is smaller or greater than 6, e.g. lying in the range 2 to 10.

1. A massage device, comprising:
support means: and
massage fingers that are distributed on the support means and that are pivotally mounted via their proximal portions of the massage fingers to the support means in such a manner that their distal ends of the massage fingers move apart from one another when they the massage fingers are pressed against a scalp,
wherein
the proximal portion of each massage finger is connected to the support means via hinge means that define at least one pivot axis for the finger, and
the support means include pivot-limiter means for the fingers that define the most spaced-apart position for the distal ends of the massage fingers.

2. The device according to claim 1, characterized in that wherein the massage fingers are distributed about an axis of the support means in such a manner that their the distal ends of the support fingers move apart from one another in a substantially radial direction relative to said axis of the support means when they are pressed against the scalp.

3. The device according to claim 1, wherein the support means include at least one cosmetic dispenser duct for being in fluid-flow communication with a container containing the cosmetic.

4. The device according to claim 3, wherein the dispenser duct is connected to at least one orifice that opens out in the vicinity of the massage fingers.

5. The device according to claim 3, wherein the dispenser duct is connected to one end of an internal channel of each massage finger, the an other end of which channel opens out onto the distal end of the massage finger.

6. The device according to claim 1, wherein the hinge means of each finger comprise a pivot that is carried either by the support means and engaged in a bearing or orifice of complementary shape of the proximal portion of the massage finger or else by the proximal portion of the massage finger and engaged in a bearing or orifice of complementary shape of the support means, so as to guide the finger in pivoting about an axis defined by the pivot.

7. The device according to claim 1, characterized in that wherein the hinge means of each massage finger comprise a film or a film-hinge of material that is deformable, connecting the finger to the support means.

8. The device according to claim 7, wherein
the support means include a ring that is connected to the massage fingers via the films of deformable material, and
the ring, the films, and the fingers, are a single piece.

9. The device according to claim 1, wherein the support means include a hoop that carries elastically-deformable tongues that bear against the fingers so as to urge them into a rest position in which the distal ends of the massage fingers are close together.

10. The device according to any preceding claim 1, wherein the support means include openings that are substantially radial, and through which the massage fingers pass and move.

11. The device according to claim 9, wherein
the support means include openings that are substantially radial, and through which the massage fingers pass and move, and
each tongue of the hoop is housed, at least in part, in one of the openings.

12. The device according to claim 1, wherein the pivot-limiter means for the massage fingers are formed by first abutment means that are carried by an annular collar that extends around the proximal portions of the massage fingers.

13. The device according to claim 1, wherein the support means include second abutment means for the massage fingers that defines the a closest-together position for the distal ends of the fingers.

14. The device according to claim 1, wherein a number of massage fingers distributed on the support means is two to twelve massage fingers.

15. The device according to claim 1, wherein it the device includes resilient return means that co-operate with the massage fingers so as to urge them from a spaced-apart position to a close-together position.

16. The device according to claim 15, wherein the resilient return means are independent of the support means.

17. The device according to claim 15, wherein the resilient return means comprise an elastically-deformable ring mounted around the massage fingers and that bears against the massage fingers.

18. The device according to claim 1, wherein
the support means include a fastener sleeve for fastening on the a neck of a container containing a cosmetic, and
the neck defines a dispenser opening for dispensing said the cosmetic.

19. The device according to claim 1, wherein
the pivot-limiter means for the massage fingers are formed by tongues that are flexible or elastically deformable and that extend between the support means and the massage fingers,
the pivoting of the fingers causing the tongues to deform, and
the deformation capacity of the tongues defines a pivot amplitude of the massage fingers.

20. The device according to claim 19, wherein
each tongue is substantially U-shaped in its unstressed state, and
each tongue includes one end that is connected to a massage finger, and an opposite end that is connected to the support means, the ends moving apart from each other while the finger is pivoting.

21. The device according to claim 19, wherein each finger is connected to one or two tongues.

22. The device according to any one of claims claims 19, wherein the massage fingers, the tongues, and the support means are formed as a single piece.

23. The device according to any one of claims claim 19, wherein the massage fingers are connected at their proximal ends to an annular crown that is subdivided into sectors, each crown sector being connected to the support means via one or more tongues having a deformation capacity and via the finger hinge means.

24. A cosmetic container including a dispenser opening for dispensing a cosmetic, wherein a device according to claim 1 is mounted on a dispenser opening of the container.

25. The container according to claim 24, wherein
the device is mounted on the container by means of a dispenser system, and
the pivot-limiter means for the massage fingers of the device form a bearing surface for actuating the dispenser system by the fingers pressing against said surface.

26. The massage device according to claim 1, wherein the massage device is configured for massaging a scalp.

27. The container according to claim 25, wherein the dispenser system comprises a pump or a valve.
